(19) United States
(12) Patent Application Publication
(10) Pub. No.: US 2006/0274050 A1
(43) Pub. Date: Dec. 7, 2006

(54) Touchpad supporting two-side operation

(76) Inventor: Jia-Yih Lii, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/318,879

(22) Filed: Dec. 28, 2005

(30) Foreign Application Priority Data
Jun. 6, 2005 (TW) 094118638

(51) Int. Cl. G09G 5/00

(52) U.S. Cl. 345/173

(57) ABSTRACT

For supporting two-side operation, a touchpad comprises a sensor, an insulator layer above the sensor for providing an operation area, and a button operation conductor under the sensor to be moved to connect to or approach the sensor for triggering a button function.

### FIELD OF THE INVENTION

The present invention is related generally to a touchpad and, more particularly, to a touchpad supporting two-side operation.

### BACKGROUND OF THE INVENTION

Due to the compactness, low cost, low power consumption and long lifetime, touchpad has been widely used in various electronic products such as notebook computer, mouse, MP3 player, and mobile phone, etc., as an input device. For operating a touchpad, user needs only to use his finger or conductor such as touch pen to touch or slide on a panel of the touchpad to move a cursor on a window or to perform other extended functions such as virtual button function, and by which, various input functions such as text writing, scrolling and button pressing can be performed. However, the panel of a touchpad has a smooth surface and a touchpad only supports single-side operation, and therefore, when a touchpad is operated in virtual button mode, no definite action is practiced by the user in the operation as operating with a real button. In order for a virtual button operation to be more like a real button operation and for supporting the general touchpad operation in the mean time, there are proposed two technologies. In the first technology, button and touchpad are two separate components and they are two real components in terms of product appearance as shown in FIGS. 1A and 1B. In the second technology, button and touchpad are two separate components but it is a single-piece component in terms of product appearance as shown in FIG. 2A. When a button is used in operation, as shown in FIG. 1A, the real button 100 is used for direct input. As shown in FIG. 1B, when the real button 100 is unveiled, the operation area 110 of a touchpad will be exposed, which comprises a handwriting area 120, an enter button 130, an undo button 140, direction buttons 150 and 152 and Chinese/English text switch buttons 160 and 162. Although this structure implements both button and touchpad functions, it uses two separate and independent components and therefore, the product is bulky and of high cost. Referring to FIGS. 2A and 2B, via the through-hole 220 corresponding to the real button 200 above a touchpad 210, when the real button 200 is pressed, the button detection mechanism under the touchpad 210 can be activated through the through-hole 220 to complete the button input operation. If the touchpad function is to be used for handwriting input, since the touchpad 210 is arranged under the real button 200, the handwriting input operation can thus be done directly on the real button 200. Although such structure looks like a one-piece structure in appearance, practically speaking, the detection of the button signal is not executed by the touchpad 210 and therefore, in order to distinguish whether the function in use is either the button function or the touchpad function, basically, the design is mainly based on the button function but sacrifices the touchpad function. The result is, the response of the touchpad function becomes slower and efficiency becomes worse, this could bring inconvenience to use, and moreover, since the button and the touchpad are actually two separate components, the cost is thus difficult to be reduced.

Therefore, it is desired a touchpad that supports both touch-sense and real button functions.

### SUMMARY OF THE INVENTION

One object of the present invention is to provide a touchpad supporting two-side operation.

According to the present invention, a touchpad supporting two-side operation comprises a sensor, an insulator layer above the sensor for providing an operation area, and a button operation conductor under the sensor to connect to or approach the sensor to activate a button function.

In one embodiment, the sensor is formed on a printed circuit board and a conductor line connected to the sensor is under the printed circuit board, such that the button operation conductor activates the button function by connecting to the conductor line to in turn indirectly connect to the sensor.

In another embodiment, a sensor is formed on a printed circuit board and a button operation conductor under the printed circuit board approaches the sensor by approaching the printed circuit board so as to activate a button function.

In yet another embodiment, a sensor comprises a capacitive sensing conductor having a first axis conductor and a second axis conductor, and an insulator layer is arranged between the capacitive sensing conductor and a button operation conductor. There is a hole in the insulator layer for the button operation conductor to pass through to connect to the first axis conductor and/or the second axis conductor in order to activate a button function.

In still another embodiment, a sensor comprises a first axis conductor, a second axis conductor, and an insulator layer between the first axis conductor and the second axis conductor. There is a hole in the insulator layer for the second axis conductor to pass through to connect to the first axis conductor to activate a button function.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIGS. 1A and 1B show an apparatus employing a conventional touchpad of single-side operation function;

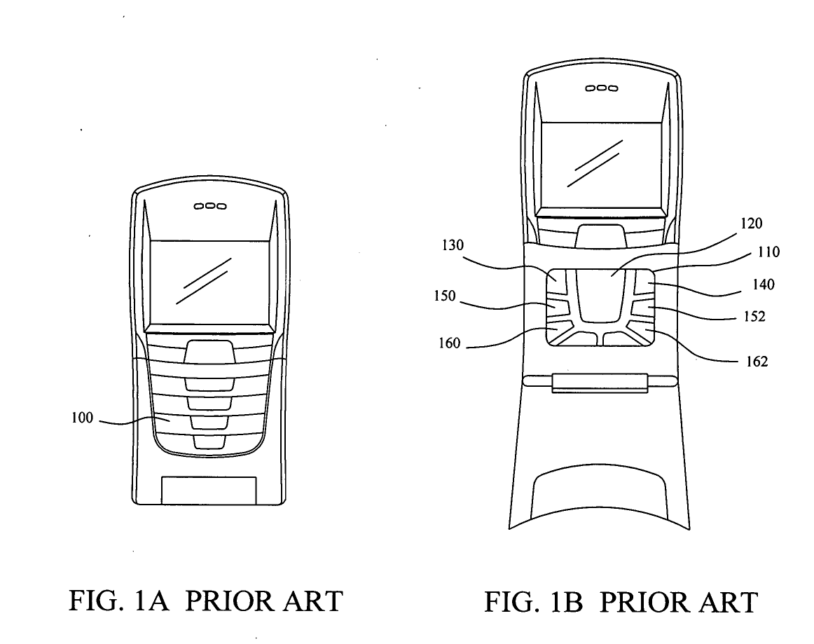

FIGS. 2A and 2B show an apparatus employing another conventional touchpad of single-side operation function;

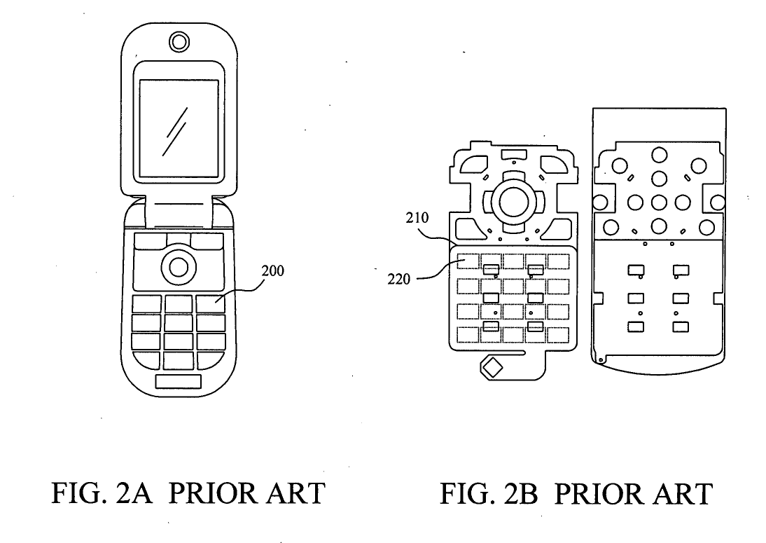

FIG. 3 is a cross-sectional view of a touchpad supporting two-side operation according to the present invention;

FIG. 4A shows the structure of an upper layer of the printed circuit board in FIG. 3;

FIG. 4B shows the structure of a lower layer of the printed circuit board in FIG. 3;

FIG. 5 is the top view of another sensor;

FIG. 6A is a cross-sectional view of a second touchpad supporting two-side operation according to the present invention;

FIG. 6B shows the structure of an upper layer of the printed circuit board in FIG. 6A;

FIG. 6C shows the structure of a lower layer of the printed circuit board in FIG. 6A;

FIG. 7A shows an expanded and a cross-sectional view of a third touchpad supporting two-side operation according to the present invention;

FIG. 7B shows a decomposition of the structure shown in FIG. 7A;

FIG. 8A shows an expanded and a cross-sectional view of a fourth touchpad supporting two-side operation according to the present invention; and

FIG. 8B shows a decomposition of the structure shown in FIG. 8A.

### DETAILED DESCRIPTION OF THE INVENTION

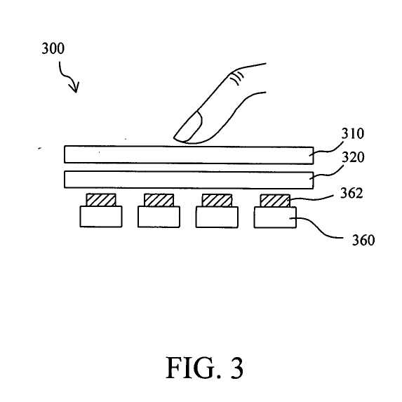

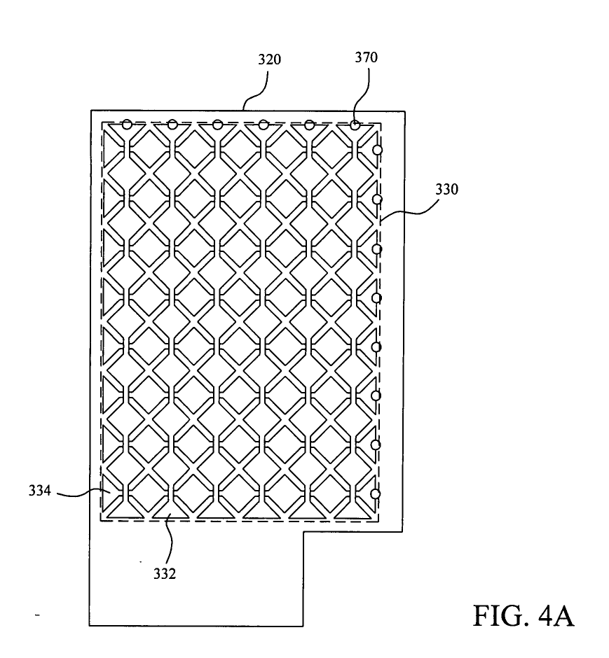

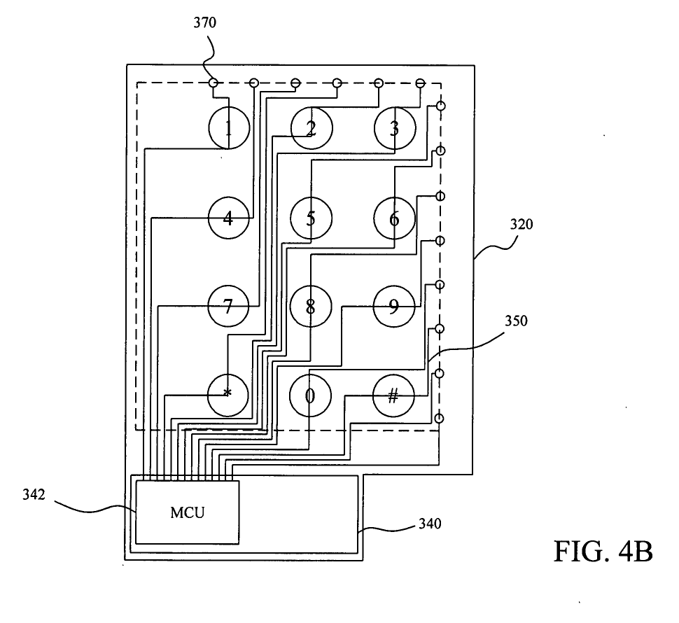

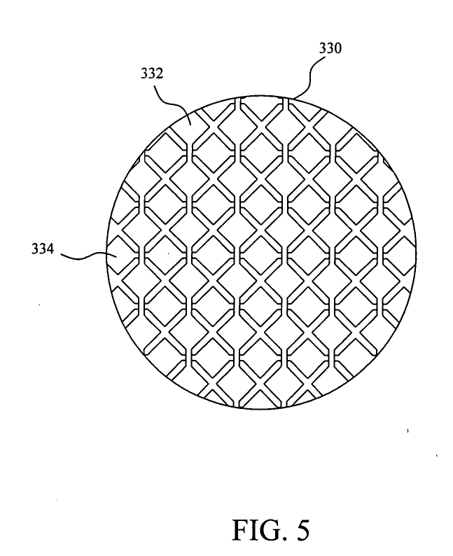

FIG. 3 is a cross-sectional view of a touchpad 300 supporting two-side operation according to the present invention, and FIGS. 4A and 4B show the structures of an upper layer and a lower layer of the printed circuit board 320 in the touchpad 300. Referring to FIGS. 3, 4A and 4B, in addition to the printed circuit board 320, the touchpad 300 further comprises a sensor 330 above the printed circuit board 320, several conductor lines 350 and a component area 340 under the printed circuit board 320, an insulator layer 310 above the sensor 330 for providing an operation area, several button operation conductors 362 under the printed circuit board 320, and several real buttons 360 corresponding to the button operation conductor 362. The sensor 330 has first axis conductors 332 and second axis conductors 334 arranged in a matrix, and the conductor line 350 connects the first axis conductors 332 and the second axis conductors 334 to a microprocessor control unit 342 in the component area 340 via a through-hole 370 in the printed circuit board 320. When finger or conductor such as touch pen touches on the insulator layer 310, an electric potential change will be produced in the sensor 330 and therefore general function input can be performed on the touchpad 300. Alternatively, when the real button 360 is pressed, the button operation conductor 362 will contact at least one conductor line 350 and connect to the sensor 330 through the conductor line 350 accordingly, and an electric potential change will be produced in the sensor 330 to activate a button function of the touchpad 300. Therefore, the touchpad 300 can support two-side operation, i.e., the front side of the touchpad 300 is for the general function and the back side of the touchpad 300 is for the button operation function. The layout of the conductor lines 350 can be so designed in different embodiments to satisfy the various requirements for specific button operations. In different embodiments, the sensor 330 can have different shapes such as the round shape shown in FIG. 5.

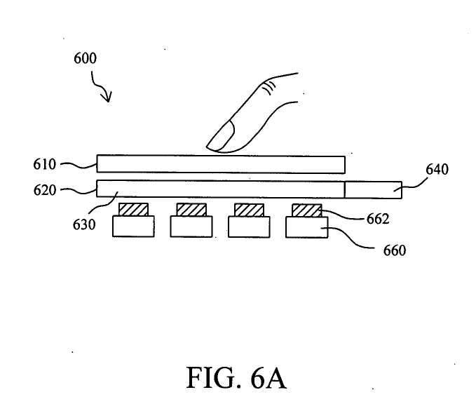

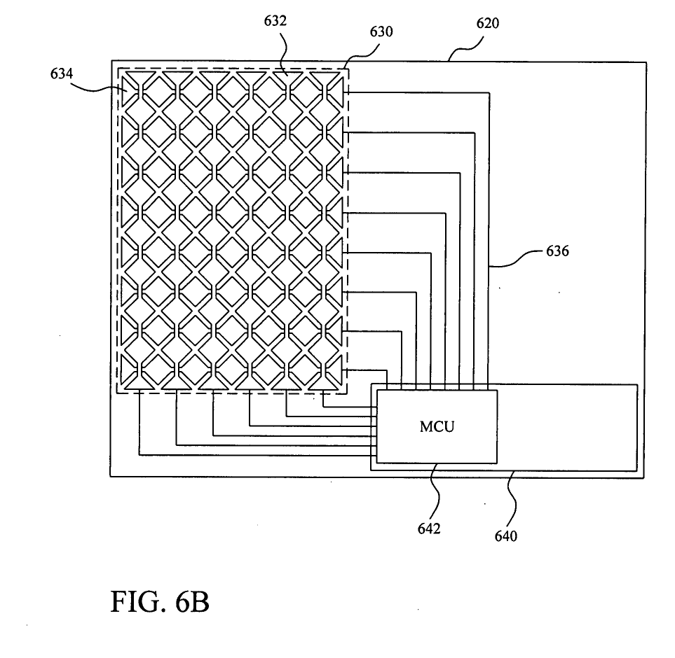

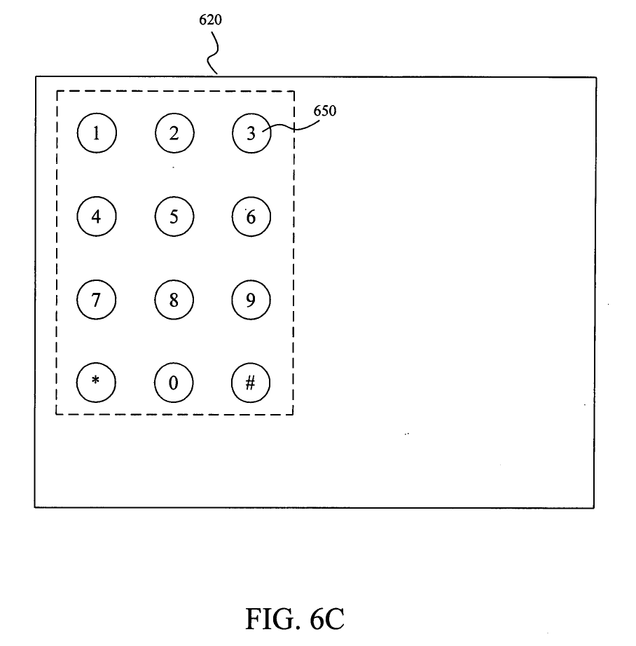

FIG. 6A is a cross-sectional view of a second touchpad 600 supporting two-side operation according to the present invention, and FIGS. 6B and 6C show the structures of an upper layer and a lower layer of the printed circuit board 620 in the touchpad 600. In the touchpad 600, referring to FIGS. 6A-6C, a sensor 630 and a component area 640 are arranged on the printed circuit board 620, the component area 640 is also located at the peripheral of the sensor 630, an insulator layer 610 covers on the sensor 620 for providing an operation area, several button areas 650 are defined on the bottom surface of the printed circuit board 620, several button operation conductors 662 corresponding to the button areas 650 are arranged under the printed circuit board 320, and several real buttons 660 are provided corresponding to the button operation conductors 662. The sensor 630 has first axis conductors 632 and second axis conductors 634 arranged in a matrix, conductor lines 636 are used to connect the first axis conductors 632 and the second axis conductors 634 to a microprocessor control unit 642 in the component area 640. When finger or conductor such as touch pen touches on the insulator layer 610, an electric potential change will be produced in the sensor 630, and general function input can be performed on the touchpad 600. Alternatively, when the real button 660 under the printed circuit board 620 is pressed, the button operation conductor 662 will contact the button area 650 to produce an electric potential change in the sensor 630 to activate a button function of the touchpad 600. Therefore, two-side operation is achieved for the touchpad 600. In this embodiment, there is no additional through-hole process for the printed circuit board 620, and the button area 650 is defined directly on the bottom surface of the printed circuit board 620, and therefore, no additional layout work is required, and the goals of low cost and application flexibility can thus be achieved.

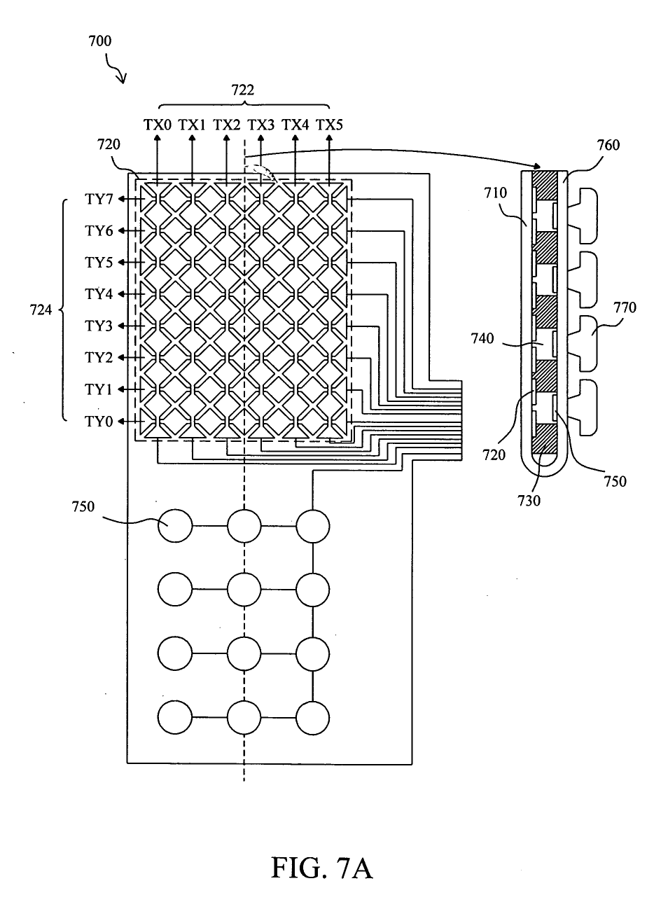

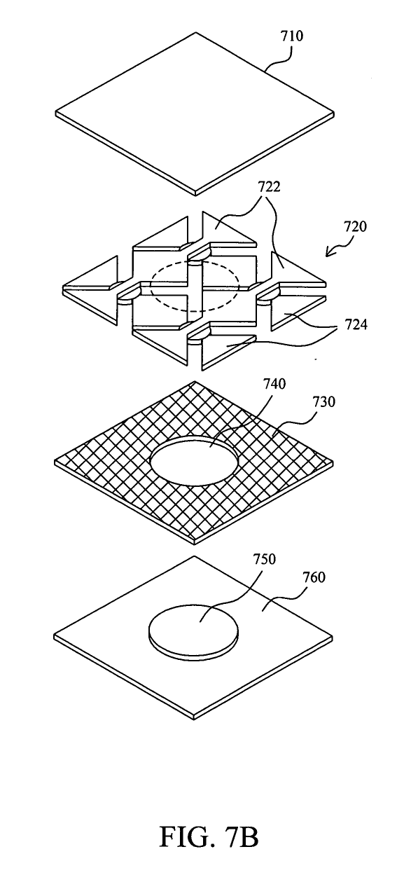

FIG. 7A shows an expanded and a cross-sectional view of a touchpad 700 supporting two-side operation according to the present invention, and FIG. 7B shows a decomposition of the structure shown in FIG. 7A. In the touchpad 700, referring to FIGS. 7A and 7B, a capacitive sensing conductor 720 comprising a plurality of first axis conductors 722, TX0 to TX5, and a plurality of second axis conductors 724, TY0 to TY7, is arranged between an insulator layer 710 and a bottom plate 760, an insulator layer 730 is further inserted between the capacitive sensing conductor 720 and the bottom plate 760, several holes 740 are opened in the insulator layer 730, several button operation conductors 750 corresponding to the holes 740 are arranged above the bottom plate 760, and several real buttons 770 are arranged under the bottom plate 760 corresponding to the button operation conductors 750. When finger or conductor such as touch pen slides on the insulator layer 710, general function input can be performed on the touchpad 700. When the real button 770 is pressed, the button operation conductor 750 above the bottom plate 760 will be moved to pass through the hole 740 of the insulator layer 730 to touch the first axis conductor 722 and the second axis conductor 724 of the capacitive sensing conductor 720, and therefore, the first axis conductor 722 and the second axis conductor 724 are connected to each other through the button operation conductor 750 such that the electric potential on the touchpad 700 is significantly changed to activate a button function. As such, it is achieved the purpose of supporting two-side operation on the touchpad 700. In different embodiments, the location of the hole 740 in the insulator layer 730 are arranged for specific applications for the button operation conductor 750 to touch either the first axis conductor 722 or the second axis conductor 724 in response to the pressing of the real button 770, to causes an electric potential change on the touchpad 700 to trigger a button function.

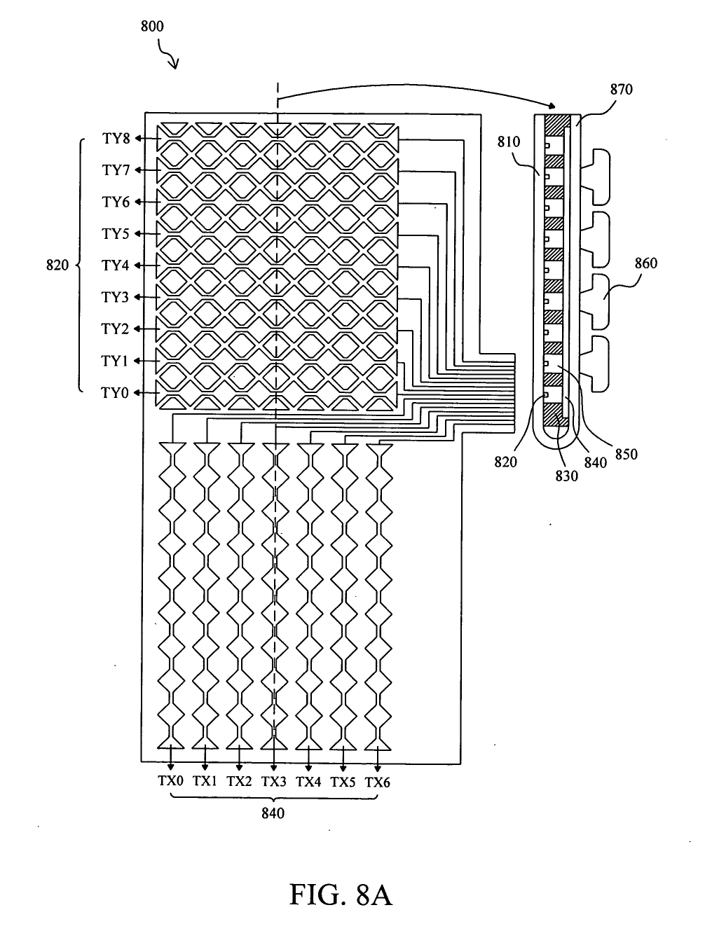

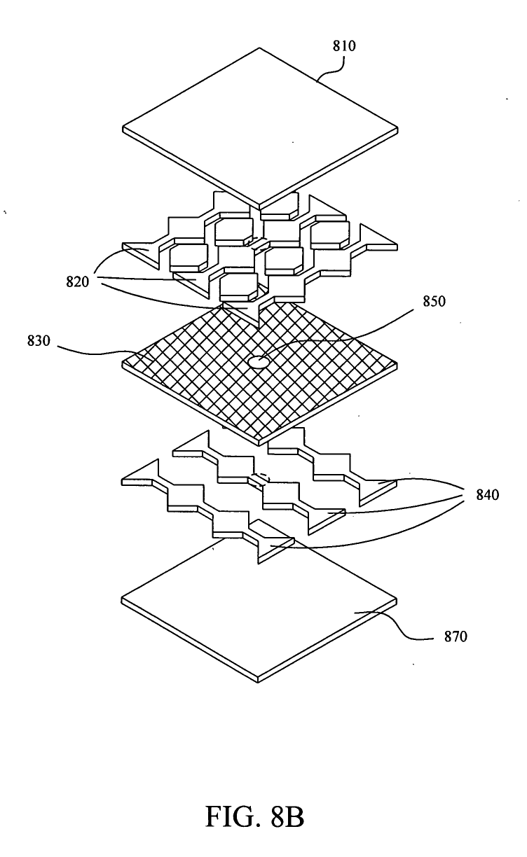

FIG. 8A shows an expanded and a cross-sectional view of a touchpad 800 supporting two-side operation according to the present invention, and FIG. 8B shows a decomposition of the structure shown in FIG. 8A. In the touchpad 800, referring to FIGS. 8A and 8B, first axis conductors 820, TY0 to TY8, and second axis conductors 840, TX0 to TX6, between an insulator layer 810 and a bottom plate 870 are separated by an insulator layer 830, several holes 850 are opened in the insulator layer 830, several real buttons 860 corresponding to the holes 850 are arranged under the bottom plate 870. Using finger or conductor such as touch pen to slide on the insulator layer 810 may perform general function input on the touchpad 800. When the real button 860 is pressed, the second axis conductor 840 will pass through the hole 850 in the insulator layer 830 to connect to the first axis conductor 820 to cause an electric potential change on the first axis conductor 820 or the second axis conductor 840 to trigger a button function. Therefore, the goal of supporting two-side operation is achieved for the touchpad 800.

A touchpad supporting two-side operation according to the present invention accomplishes two types of inputs, touch sense and button function, by using only one component, and the ultimate goals to reduce components and cost of an electronic product and to increase convenience of the use are achieved.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set fourth in the appended claims.

What is claimed is:

1. A touchpad supporting two-side operation, comprising:
a sensor;
an insulator layer above the sensor for providing an operation area;
a button operation conductor under the sensor; and
a real button arranged corresponding to the button operation conductor such that when the real button is pressed the button operation conductor will connect to or approach the sensor to activate a button function.

2. The touchpad of claim 1, wherein the sensor comprises a plurality of first axis conductors and second axis conductors arranged in a matrix.

3. The touchpad of claim 1, wherein the sensor is formed on a printed circuit board.

4. The touchpad of claim 3, further comprising a button area defined on a bottom surface of the printed circuit board such that when the real button is pressed the button operation conductor will touch the button area to trigger the button function.

5. The touchpad of claim 3, wherein the printed circuit board comprises a through-hole and a conductor line passing through the through-hole to connect to the sensor such that when the real button is pressed the button operation conductor will connect to the conductor line to trigger the button function.

6. A touchpad supporting two-side operation, comprising:
a first insulator layer for providing an operation area;
a bottom plate having a button operation conductor thereabove;
a capacitive sensing conductor between the first insulator layer and the bottom plate;
a real button corresponding to the button operation conductor arranged under the bottom plate; and
a second insulator layer between the capacitive sensing conductor and the bottom plate, having a hole for the button operation conductor to pass through to touch the capacitive sensing conductor to trigger a button function when the real button is pressed.

7. The touchpad of claim 6, wherein the capacitive sensing conductor comprises a plurality of first axis conductors and second axis conductors arranged in a matrix.

8. A touchpad supporting two-side operation, comprising:
a first insulator layer for providing an operation area;
a bottom plate;
a first axis conductor and a second axis conductor between the first insulator layer and the bottom plate;
a real button under the bottom plate; and
a second insulator layer between the first axis conductor and the second axis conductor, having a hole for the second axis conductor to pass through to touch the first axis conductor to trigger a button function when the real button is pressed.
